(19) United States
(12) Patent Application Publication
(10) Pub. No.: US 2024/0067545 A1
(43) Pub. Date: Feb. 29, 2024

(54) METHOD FOR CONSTRUCTING DYNAMIC-LIKE MEMBRANE TO CONTROL MEMBRANE FOULING OF MBR

(71) Applicant: Xi’AN UNIVERSITY OF ARCHITECTURE AND TECHNOLOGY, Shaanxi (CN)

(72) Inventors: Rui Miao, Shaanxi (CN); Yupeng Wang, Shaanxi (CN); Lei Wang, Shaanxi (CN); Haoxue Ran, Shaanxi (CN); Chengshu Yang, Shaanxi (CN)

(73) Assignee: Xi’AN UNIVERSITY OF ARCHITECTURE AND TECHNOLOGY, Shaanxi (CN)

(21) Appl. No.: 18/457,371

(22) Filed: Aug. 29, 2023

(30) Foreign Application Priority Data
Aug. 30, 2022 (CN) 202211048473.X

(51) Int. Cl. C02F 3/12

(52) U.S. Cl. CPC C02F 3/1268; C02F 2303/16; C02F 2303/20

(57) ABSTRACT

A method for constructing a dynamic-like membrane to control membrane fouling of MBR includes: determining a critical pore size of a base material according to an average size of activated sludge in a membrane tank. The base material is detachably fixed on the outer layer of a conventional MBR module, which is placed into the membrane tank of a wastewater treatment system. Then the aeration rate of a membrane area in the MBR module is reduced. With the assistance of the driving pressure of the MBR module itself and the physical interception of the base material, the inherent activated sludge in the membrane tank is used to form a dynamic-like membrane on the surface of the base material. This dynamic-like membrane intercepts most activated sludge in the membrane tank, and results in a low-concentration sludge-water mixture in the MBR module, which not only reduces the foulants load of MBR membrane, but also facilitates degradation of foulants on the membrane surface, so as to realize the control of membrane fouling.

### CROSS-REFERENCE TO RELATED APPLICATION

This application claims the priority benefit of China application serial no. 202211048473.X, filed on Aug. 30, 2022. The entirety of the above-mentioned patent application is hereby incorporated by reference herein and made a part of this specification.

### BACKGROUND

### Technical Field

The disclosure belongs to the technical field of sewage treatment, and mainly relates to a method for constructing a dynamic-like membrane to control the membrane fouling of a membrane bioreactor (MBR).

### Description of Related Art

The membrane bioreactor (MBR) is a new type of wastewater treatment technology that combines membrane separation technology and biological treatment technology. With the continuous increase of requirements for environmental protection, the application scale of MBR technology in the field of wastewater treatment is still growing year by year due to its advantages in good separation performance and small footprint. However, in the actual application process, the membrane fouling will lead to a series of problems such as decrease of membrane permeation flux, deterioration of effluent quality, and increase of operating costs. The above problems have always been the main issues hindering the MBR technology from achieving efficient and low-consumption operation. Therefore, many researchers have conducted research on the prevention and control of the membrane fouling from multiple aspects such as sludge performance, membrane performance, membrane module and operation processes. Specifically, reducing the activated sludge (foulants) load of MBR membrane is one of the key strategies to mitigate membrane fouling.

There have been some reports focusing on the technical research for reducing the foulants load of MBR membrane, which are mainly divided into three categories: the earliest one is to add a pre-sedimentation tank between the biological tank and the MBR membrane tank or inside the biological tank for the supernatant to enter the MBR membrane tank, thereby reducing the concentration of activated sludge entering the membrane tank. Such method is relatively simple and easy to implement, but the pre-sedimentation tank takes up a considerably large area for the whole process, which not only loses the advantage of MBR's small footprint, but also requires the activated sludge to have better settling property. In the meantime, it is not easy to form high-concentration activated sludge in the membrane tank, which affects the treatment effect of the biological tank.

Another strategy is that, solid materials such as suspension filler, particulate matter and flocculant were added to the membrane tank to provide carriers for microorganisms, thereby reducing the foulants load of MBR membrane. Most results show that the presence of solid additives in the membrane tank could mitigate MBR membrane fouling to a certain extent. But the disadvantage is that it introduces new problems such as increased in investment cost, shortened membrane service life, accumulation of solid additives in the membrane tank and which is difficult to be separated.

Some reports also show making improvement to the structure of the membrane tank to reduce the foulants load. For example, a wastewater inlet tank is arranged at the front end of the MBR membrane tank, a filter is arranged at this wastewater inlet tank, and another wastewater inlet tank is further added after the first wastewater inlet tank, so that a two-stage treatment is adopted to reduce foulants load of MBR membrane. There is also a serpentine channel at the front end of the MBR membrane module, and a filter is added at the wastewater inlet end of each serpentine channel to reduce the concentration of activated sludge entering the MBR module. There are similar studies that add a nylon filter at the front end of the membrane module to reduce the foulants load of the MBR membrane. Similarly, such method leads to an increase in the size of the whole process, and all the sludge-water mixture entering the membrane tank needs to pass through the additional filter adopted by this type of method, which will additionally cause clogging at the filter and new fouling problems.

All of the above methods may reduce the foulants load of MBR membrane to a certain extent and realize the prevention and control of membrane fouling. However, while the foulants load is reduced, the occupied area is increased considerably, introducing secondary fouling and shortening membrane life, and the investment cost and operation energy consumption are increased as well. The above problems cause MBR to lose its own advantages, which greatly limits the development and application in engineering of these technologies. Therefore, it is still necessary to develop new technology and methods continuously for solving the existing technical problems and realizing effective control of membrane fouling in MBR.

### SUMMARY

In view of the key technical problems currently encountered by the field of membrane fouling control of membrane bioreactor (MBR), the purpose of this disclosure is to provide a method for constructing a dynamic-like membrane to control the membrane fouling of MBR, and reduce the foulants load on the membrane surface in MBR without introducing other unfavorable factors, thereby realizing the control of membrane fouling and solving the deficiencies in the related art.

The present disclosure is achieved through the following technical solutions.

The disclosure provides a method for constructing a dynamic-like membrane to control the membrane fouling of MBR, and the method includes: determining the critical pore size of a base material on the outer layer of a MBR module according to the quantitatively measured average size of activated sludge in the membrane tank; placing the MBR module provided with the base material in a membrane tank of a wastewater treatment system, and reducing the aeration rate to the membrane area of the MBR module in the membrane tank. Under a constant flow mode, with the assistance of the driving pressure of the MBR module itself and the physical interception of the base material, the inherent activated sludge in the membrane tank is used to induce formation of a dynamic-like membrane on the surface of the base material. Then, the dynamic-like membrane is used as a boundary to intercept most large size activated sludge in the membrane tank, resulting in a low-concentration sludge-water mixture in the MBR module. During operation process of the MBR, when the liquid level of the MBR module is lowered, the dynamic-like membrane on the surface of the base material on the outer layer of the MBR module is removed through physical cleaning.

Preferably, the critical pore size of the base material and the average size of the activated sludge in the membrane tank satisfy the following relationship that the critical pore size of the base material ranges from 20% of the average size of the activated sludge to 50% of the average size of the activated sludge.

Preferably, a stainless steel screen mesh or a stainless steel perforated mesh plate with a thickness of 15-100 μm and a pore size of 100 meshes to 1000 meshes is selected as the base material.

Preferably, the base material adopts welding, clasps, screws, Velcro tapes, cable ties, magnet strips or is prepared as a frame set on the outer layer of the MBR module.

Preferably, the aeration rate to the membrane area of MBR is 20% to 50% of the design value, and the flow rate involved in the constant flow mode is 12 L·m⁻²·h⁻¹ to 17 L·m⁻²·h⁻¹.

Preferably, the physical cleaning method for the base material on the outer layer of the MBR module includes online aeration backwashing, hydraulic backflushing, mechanical scraping or flushing.

The present disclosure has the following advantageous effects due to the use of the above technical solutions:

1. The method for constructing a dynamic-like membrane to control the membrane fouling of MBR provided by the present disclosure is to fix the millimeter-level detachable base material on the outer layer of the MBR module, and with assistance from the driving pressure of the MBR module itself and the physical interception of the base material, the activated sludge in the membrane tank is used to form a dynamic-like membrane on the surface of the base material. That is, inherent activated sludge in wastewater treatment system is used to construct a dynamic-like membrane to control the membrane fouling of MBR. The use of millimeter-level detachable base material does not require additional space, and it is also not necessary to require additional investment in structures and operating costs.

2. This dynamic-like membrane could intercept >70% of the activated sludge on the outer layer of the MBR module, thus reducing the foulants load of MBR membrane. On the other hand, it could change the microenvironment of MBR membrane surface effectively, which leads to the evolution of community structure and functional characteristics of microorganisms on the membrane surface, so as to enhance the degradation of foulants on the membrane surface, thereby realizing the control of the membrane fouling effectively. Under the same wastewater quality conditions, when the transmembrane pressure reaches 30 kPa, the MBR operation time of the dynamic-like membrane as constructed is increased by 1 time to 15 times.

3. The reduction of aeration rate to the membrane area of MBR not only leads to a reduction in operation energy consumption, but also reduces the degree of movement of the membrane filaments, thereby reducing membrane filaments breakage risk and increasing the service life of membrane products to a certain extent, and further decreasing the operating costs. Moreover, this method is simple, convenient and practicable. It is well suited for large scale production, and not only suitable for MBR modules before production, but also may be used for improving and modifying MBR modules in current engineering operations.

### BRIEF DESCRIPTION OF THE DRAWINGS

The accompanying drawings described here are used to provide a further understanding of the present disclosure, constitute a part of the present disclosure, and do not constitute an improper limitation of the present disclosure. In the accompanying drawings:

FIG. 1a is a schematic diagram of the frame of a conventional MBR module.

FIG. 1B is a schematic diagram showing the MBR frame constructed with a dynamic-like membrane.

FIG. 2 shows the variation characteristics of transmembrane pressure of MBR with dynamic-like membrane (100 meshes) and without dynamic-like membrane.

FIG. 3 shows the variation characteristics of transmembrane pressure of MBR with dynamic-like membrane (400 meshes) and without dynamic-like membrane.

FIG. 4 shows the variation characteristics of transmembrane pressure of MBR with dynamic-like membrane (800 meshes) and without dynamic-like membrane.

FIG. 5 shows the variation characteristics of transmembrane pressure of MBR with dynamic-like membrane (1000 meshes) and without dynamic-like membrane.

### DESCRIPTION OF THE EMBODIMENTS

The present disclosure will be described in detail below in conjunction with the accompanying drawings and specific embodiments, where the schematic embodiments and descriptions of the present disclosure are used to explain the present disclosure, but not to limit the present disclosure.

An embodiment of the disclosure provides a method for constructing a dynamic-like membrane to control the membrane fouling of membrane bioreactor (MBR), and the method includes the following steps.

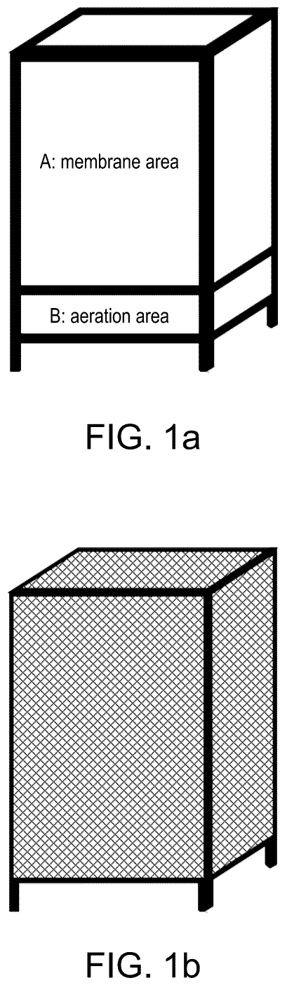

1) First, during the actual operation of the wastewater treatment system, the laser particle size analyzer is used to measure the average size d of the activated sludge in the membrane tank. On basis of the above, combined with the probability of the activated sludge passing through the base material, the adhesion behavior of activated sludge on the surface of the base material, the formation rate of the dynamic-like membrane and the characteristics of porosity change of the base material during the operation process, it is possible to determine the critical pore size D of the base material on the outer layer of the conventional MBR module. The relationship between the two satisfies the following: 0.2d≤D≤0.5d. FIG. 1a is a schematic diagram of the frame of a conventional MBR module.

2) According to the monitoring of the size of the activated sludge in several typical wastewater treatment plants, it is obtained that the average size d of the activated sludge is in the range of 65-300 μm. According to 0.2d≤D≤0.5d determined in step 1), it is determined that critical pore size D of the base material is 13-150 μm, and it is selected that the critical pore size D of the base material is 100 meshes to 1000 meshes.

According to the filter resistance of the base material before and after the dynamic-like membrane is constructed, the formation frequency of the liquid level difference between the inside and outside of the base material, the coverage of the pores of the base material and so on in the operation process, the thickness parameter of the base material is determined to be 15-100 μm. Based on the interface performance of the base material, the base material is detachably fixed on the outer layer of the conventional MBR module by means of welding, clasps, screws, Velcro tapes, cable ties, magnet strips or preparation into a frame.

3) The MBR module equipped with the base material is placed into the membrane tank of the wastewater treatment system for actual operation and debugging. Based on the thickness, looseness, shedding frequency, microbial characteristics, etc. of the dynamic-like membrane, the aeration rate of the aeration area B to the membrane area A is reduced to 20% to 50% of the design value. Based on the interface properties such as the roughness, porosity, water permeability, pore size, and thickness of the base material, and with the assistance of the driving pressure of the MBR module itself and the physical interception of the base material, the inherent activated sludge in the membrane tank is used to form a dynamic-like membrane on the surface of the base material under the constant flow mode. The flow rate involved in the constant flow mode is 12 L·m⁻²·h⁻¹ to 17 L·m⁻²·h⁻¹. The MBR frame constructed with a dynamic-like membrane is shown in FIG. 1B. With the dynamic-like membrane as the boundary, most large size activated sludge is intercepted in the membrane tank, and a low-concentration sludge-water mixture is present in the MBR module.

4) During the operation process of MBR, when the liquid level in the MBR module decreases, based on the performance of the base material interface and the performance of the formed dynamic-like membrane, physical cleaning such as online aeration backwashing, hydraulic backflushing, mechanical scraping or flushing is selected to clean the base material on the outer layer of the MBR module.

The present disclosure will be described in further detail below through specific examples.

### Example 1

The operation of a typical activated sludge wastewater treatment system during June to August in 2022 (summer) was taken as an example.

1) The average size d of the activated sludge measured by a laser particle size analyzer was 300 μm. The relationship between the critical pore size D of the base material on the outer layer of the conventional MBR module and the average size d of the activated sludge was: D=0.5×d. It was determined that the critical pore size of the base material was 150 μm, that was, 100 meshes.

2) A stainless steel perforated mesh plate with a thickness of 100 μm and a pore size of 100 meshes was selected as the base material and prepared as a frame by welding, which was detachably fixed on the outer layer of the conventional MBR module.

3) The MBR module provided with the base material was placed into the membrane tank of the wastewater treatment system. The aeration rate of aeration area B to membrane area A in the membrane tank was reduced to 50% of the design value. Under 12 L·m⁻²·h⁻¹ constant flow condition, with the assistance of the driving pressure of the MBR module itself and the physical interception of the base material, the inherent activated sludge in the membrane tank was used to form a dynamic-like membrane on the surface of the base material. With the dynamic-like membrane as the boundary, most large size activated sludge was intercepted in the membrane tank, and a low-concentration sludge-water mixture was present inside the MBR module.

4) During the operation process, when the liquid level in the MBR module decreased, online aeration backwashing was used to clean the base material.

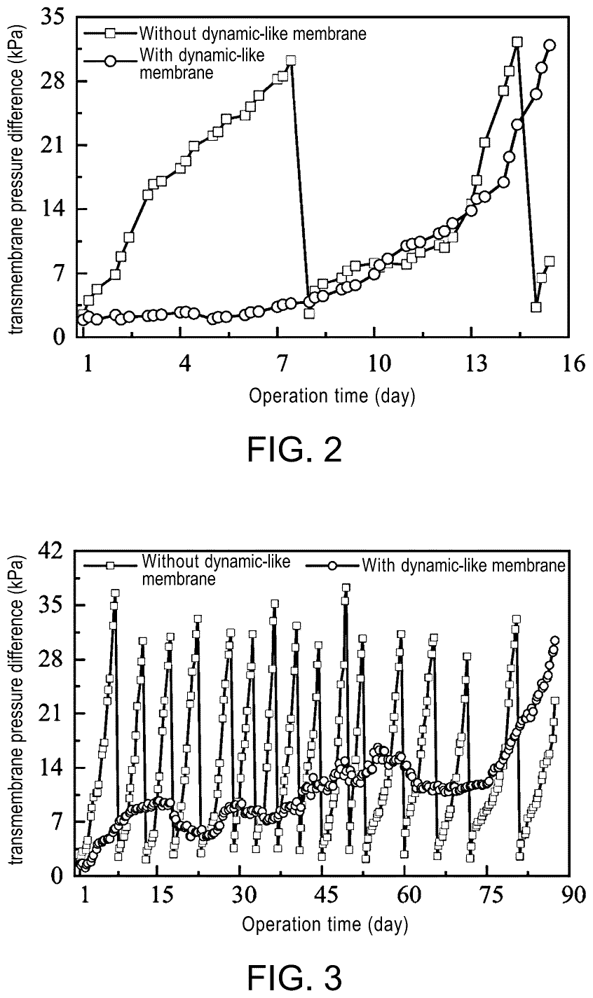

As shown in FIG. 2, under the same wastewater quality condition, the MBR that was not constructed with the dynamic-like membrane had a transmembrane pressure increased to 30 kPa when it had been operated for 7 days, and a corresponding MBR membrane cleaning strategy must be implemented. In contrast, the MBR that was constructed with the dynamic-like membrane had a transmembrane pressure increased to 30 kPa when it had been operated for 15 days, which meant that the operation time was doubled.

### Example 2

The operation of a typical activated sludge wastewater treatment system during April to November in 2021 (spring, summer, autumn) was taken as an example.

1) The average size d of the activated sludge measured by a laser particle size analyzer was 110 μm. The relationship between the critical pore size D of the base material on the outer layer of the conventional MBR module and the average size d of the activated sludge was: D=0.35×d. It was determined that the critical pore size of the base material was 38.5 μm, that was, 400 meshes.

2) A stainless steel screen mesh with a thickness of 30 μm and a pore size of 400 meshes was selected as the base material, which was detachably fixed on the outer layer of the conventional MBR module through a clasp.

3) The MBR module provided with the base material was placed into the membrane tank

of the wastewater treatment system. The aeration rate of aeration area B to membrane area A in the membrane tank was reduced to 35% of the design value. Under 14 L·m⁻²·h⁻¹ constant flow condition, with the assistance of the driving pressure of the MBR module itself and the physical interception of the base material, the inherent activated sludge in the membrane tank was used to form a dynamic-like membrane on the surface of the base material. With the dynamic-like membrane as the boundary, most large size activated sludge was intercepted in the membrane tank, and a low-concentration sludge-water mixture was present in the MBR module.

4) During the operation process, when the liquid level in the MBR module decreased, flushing was used to clean the base material.

As shown in FIG. 3, under the same wastewater quality condition, the MBR that was constructed with the dynamic-like membrane had a transmembrane pressure increased to 30 kPa when it had been operated for 90 days, while the MBR that was not constructed with the dynamic-like membrane had been subjected to 15 times membrane cleaning strategy during the same period of operation time, which meant that the operation time of the MBR constructed with the dynamic-like membrane was extended by 15 times.

### Example 3

The operation of a typical activated sludge wastewater treatment system from March to June in 2022 (spring and early summer) was taken as an example.

1) The average size d of the activated sludge measured by a laser particle size analyzer was 80 μm. The relationship between the critical pore size D of the base material on the outer layer of the conventional MBR module and the average size d of the activated sludge was: D=0.23×d. It was determined that the critical pore size of the base material was 18.4 μm, that was, 800 meshes.

2) A stainless steel screen mesh with a thickness of 25 μm and a pore size of 800 meshes was selected as the base material, which was detachably fixed on the outer layer of the conventional MBR module through a Velcro tape.

3) The MBR module provided with the base material was placed into the membrane tank of the wastewater treatment system. Then the aeration rate of aeration area B to membrane area A in the membrane tank was reduced to 30% of the design value. Under 15 L·m⁻²·h⁻¹ constant flow condition, with the assistance of the driving pressure of the MBR module itself and the physical interception of the base material, the inherent activated sludge in the membrane tank was used to form a dynamic-like membrane on the surface of the base material. With the dynamic-like membrane as the boundary, most large size activated sludge was intercepted in the membrane tank, and a low-concentration sludge-water mixture was formed in the MBR module.

4) During the operation process, when the liquid level in the MBR module decreased, hydraulic back flushing was used to clean the base material.

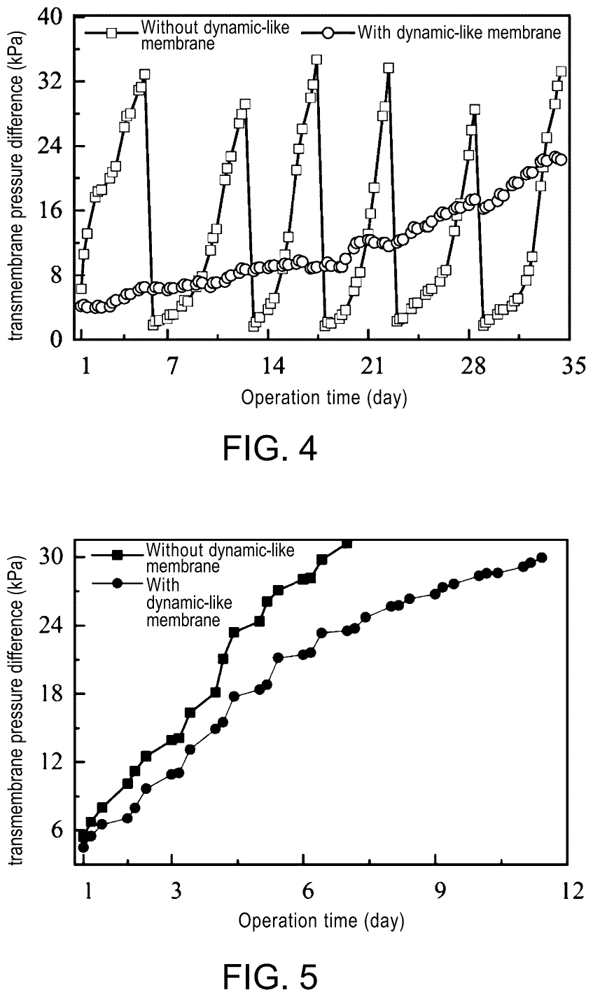

As shown in FIG. 4, under the same wastewater quality condition, the MBR that was constructed with the dynamic-like membrane had a transmembrane pressure increased to 22 kPa when it had been operated for 35 days, while the MBR that was not constructed with the dynamic-like membrane had been subjected to 6 times membrane cleaning strategy during the same period of operation time, and the transmembrane pressure was increased to 33 kPa, which meant that the operation time of the MBR constructed with the dynamic-like membrane was extended by 7 times.

### Example 4

The operation of a typical activated sludge wastewater treatment system during November 2021 to January 2022 (winter) was taken as an example.

1) The average size d of the activated sludge measured by a laser particle size analyzer was 65 μm. The relationship between the critical pore size D of the base material on the outer layer of the conventional MBR module and the average size d of the activated sludge was: D=0.2×d. It was determined that the critical pore size of the base material was 13 μm, that was, 1000 meshes.

2) A stainless steel screen mesh with a thickness of 15 μm and a pore size of 1000 meshes was selected as the base material, which was detachably fixed on the outer layer of the conventional MBR module through a Velcro tape.

3) The MBR module provided with the base material was placed into the membrane tank of the wastewater treatment system. Then the aeration rate of aeration area B to membrane area A in the membrane tank was reduced to 20% of the design value. Under 17 L·m⁻²·h⁻¹ constant flow condition, with the assistance of the driving pressure of the MBR module itself and the physical interception of the base material, the inherent activated sludge in the membrane tank was used to form a dynamic-like membrane on the surface of the base material. With the dynamic-like membrane as the boundary, most large size activated sludge was intercepted in the membrane tank, and a low-concentration sludge-water mixture was formed in the MBR module.

4) During the operation process, when the liquid level in the MBR module decreased, mechanical scraping was used to clean the base material.

As shown in FIG. 5, under the same wastewater quality condition, when the transmembrane pressure reached 30 kPa, the MBR constructed with the dynamic-like membrane could operate 12 days, while the MBR without the dynamic-like membrane could operate 6 days, which meant that the operation time of the MBR constructed with the dynamic-like membrane was nearly doubled as compared with that of the MBR without the dynamic-like membrane.

As can be seen from the above examples, in the method for constructing a dynamic-like membrane to control the MBR's membrane fouling of the present disclosure, with the assistance of the driving pressure of the MBR module itself and the physical interception of the base material, the inherent activated sludge in wastewater treatment system is used to form a dynamic-like membrane to control the membrane fouling of MBR. The method of the present disclosure prolongs the operation time of MBR by 1 time to 15 times as compared with the MBR without the dynamic-like membrane, effectively mitigates the membrane fouling rate/extent, and further alleviates problems such as the decline of membrane flux, the deterioration of effluent quality and the increase of operating cost caused by membrane fouling.

The present disclosure is not limited to the above-mentioned embodiments. On the basis of the technical solutions disclosed in the present disclosure, those skilled in the art can make some replacements and modification for some of the technical features according to the disclosed technical content without creative work. These replacements and modification are within the protection scope of the present disclosure.

What is claimed is:

1. A method for constructing a dynamic-like membrane to control the membrane fouling of membrane bioreactor (MBR) comprising:
determining a critical pore size of a base material on an outer layer of a MBR module according to a quantitatively measured average size of activated sludge in a membrane tank;
placing the MBR module provided with the base material in the membrane tank of a wastewater treatment system, and reducing an aeration rate to a membrane area of the MBR module in the membrane tank; wherein in a constant flow mode, with an assistance of a driving pressure of the MBR module and a physical interception of the base material, the activated sludge in the membrane tank is used to induce formation of a dynamic-like membrane on a surface of the base material;
using the dynamic-like membrane as a boundary to intercept large size activated sludge in the membrane tank, resulting in a low-concentration sludge-water mixture in the MBR module; and
during operation process of the MBR, when a liquid level in the MBR module is lowered, the dynamic-like membrane on the surface of the base material on the outer layer of the MBR module is removed through physical cleaning.

2. The method according to claim 1, wherein the critical pore size D of the base material and the average size d of the activated sludge in the membrane tank satisfy the following relationship:
0.2d≤D≤0.5d.

3. The method according to claim 1, wherein a stainless steel screen mesh or a stainless steel perforated mesh plate with a thickness of 15-100 μm and a pore size of 100 meshes to 1000 meshes is selected as the base material.

4. The method according to claim 1, wherein the base material adopts welding, clasps, screws, Velcro tapes, cable ties, magnet strips or is prepared as a frame set on the outer layer of the MBR module.

5. The method according to claim 1, wherein the aeration rate to the membrane area of the MBR is 20% to 50% of a design value, and a flow rate involved in the constant flow mode is 12 L·m⁻²·h⁻¹ to 17 L·m⁻²·h⁻¹.

6. The method according to claim 1, wherein the physical cleaning for the base material on the outer layer of the MBR module comprises online aeration backwashing, hydraulic backflushing, mechanical scraping or flushing.

7. The method according to claim 1, wherein under the same wastewater quality condition, when a MBR transmembrane pressure reaches 30 kPa, an MBR operation time of the dynamic-like membrane as constructed is increased by 1 time to 15 times.

8. An application of the method according to claim 1 in a field of sewage treatment engineering.
